(19) United States
(12) Patent Application Publication
(10) Pub. No.: US 2025/0286295 A1
(43) Pub. Date: Sep. 11, 2025

(54) CONNECTOR

(71) Applicant: JAPAN AVIATION ELECTRONICS INDUSTRY, LIMITED, Tokyo (JP)

(72) Inventors: Atsushi KOBAYASHI, Tokyo (JP); Takashi OMODACHI, Tokyo (JP)

(73) Assignee: JAPAN AVIATION ELECTRONICS INDUSTRY, LIMITED, Tokyo (JP)

(21) Appl. No.: 19/036,207

(22) Filed: Jan. 24, 2025

(30) Foreign Application Priority Data
Mar. 6, 2024 (JP) 2024-034359

(51) Int. Cl. H01R 12/91; H01R 12/70; H01R 13/502; H01R 13/629

(52) U.S. Cl. CPC H01R 12/91; H01R 12/707; H01R 13/5025; H01R 13/629

(57) ABSTRACT

A connector comprises a hold-down and a housing which has a protected portion. The hold-down has a base portion, two side arms which are connected to opposite sides of the base portion in a width direction, respectively, and a middle arm which extends inward in a pitch direction from the base portion. Each of the side arms has a side portion which extends along the pitch direction, an extending portion which extends inward in the width direction from a lower end of the side portion and a spring portion which extends upward from the extending portion so as to be resiliently deformable. The middle arm has a protector. The protector covers the protected portion. The protected portion is formed with movement-allowance portions which allow movements of the spring portions in accordance with resilient deformations thereof, respectively. The protector is located above the movement-allowance portions.

### CROSS REFERENCE TO RELATED APPLICATIONS

This application is based on and claims priority under 35 U.S.C. § 119 to Japanese Patent Application No. JP 2024-034359 filed Mar. 6, 2024, the content of which is incorporated herein in its entirety by reference.

### BACKGROUND OF THE INVENTION

This invention relates to a connector comprising a hold-down.

For example, this type of connector is disclosed in WO2018/236070A (Patent Document 1), the content of which is incorporated herein by reference.

Referring to FIG. 15, Patent Document 1 discloses a connector 90 comprising an insulator body (housing) 92 and two guide members (hold-downs) 94. The hold-downs 94 are attached to opposite ends of the housing 92 in a pitch direction, respectively. The hold-downs 94 reinforce the housing 92 and guide a mating connector 98 when the mating connector 98 is mated with the connector 90. Referring to FIG. 15 together with FIG. 16, each of the hold-downs 94 has two contact portions (spring portions) 96. Each of the spring portions 96 works as a terminal through which a large current flows under a mated state where the connector 90 and the mating connector 98 are mated with each other.

The spring portion 96 might be brought into abutment with the mating connector 98 to buckle during a process in which the mating connector 98 is mated with the connector 90.

### SUMMARY OF THE INVENTION

It is therefore an object of the present invention to provide a connector with a structure which can prevent a spring portion of a hold-down from buckling.

An aspect of the present invention provides a connector comprising a housing and a hold-down. The housing has two long walls, two short walls, an island-like portion and a bottom portion. Each of the long walls extends along a pitch direction. Each of the short walls couples the long walls together in a width direction perpendicular to the pitch direction. The island-like portion is enclosed by the long walls and the short walls in a horizontal plane defined by the pitch direction and the width direction. The bottom portion is located at a lower side of the housing in an up-down direction perpendicular to both the pitch direction and the width direction. The bottom portion couples the island-like portion to each of the long walls and the short walls. The island-like portion has a protected portion. The protected portion is located at an end of the island-like portion in the pitch direction. The hold-down has a base portion, two side arms and a middle arm. The base portion has a cover portion. The cover portion covers the short wall from above. The two side arms are connected to opposite sides of the base portion in the width direction, respectively. Each of the side arms has a side cover, a side portion, an extending portion, a spring portion and a contact point. For each of the side arms, the side cover covers the long wall from above, the side portion is connected to an outer part of the side cover in the width direction and extends along the pitch direction, the extending portion extends inward in the width direction from a lower end of the side portion, the spring portion extends upward from the extending portion so as to be resiliently deformable, and the contact point is supported by the spring portion. The middle arm has a middle portion and a protector. The middle portion extends inward in the pitch direction from the base portion. The protector extends from the middle portion and covers the protected portion of the island-like portion. The protected portion is formed with two movement-allowance portions. The two movement-allowance portions are recessed inward in the width direction and allow movements of the spring portions in accordance with resilient deformations thereof, respectively. The protector is located above the two movement-allowance portions. Each of the side arms is formed with a bent portion which is located at a boundary between a lower end of the side portion and the extending portion.

The extending portion of the hold-down according to an aspect of the present invention can be formed by bending a metal plate, which partially forms the side portion, inward in the width direction at a lower end of the side portion. The boundary between the extending portion and the side portion is the bent portion which is formed as described above and can be securely soldered on a board. Moreover, since the spring portion according to an aspect of the present invention can be arranged in the vicinity of the island-like portion, the long wall does not need to be formed with a space which allows a resilient deformation of the spring portion. Accordingly, the housing can be improved in its strength.

The protector of an aspect of the present invention is arranged above the spring portions so that the spring portions are protected from above. The thus-arranged protector prevents the spring portions from being brought into abutment with a mating connector during a process in which the mating connector is mated with the connector, for example. Thus, an aspect of the present invention provides a connector with a structure which can prevent a spring portion of a hold-down from buckling.

An appreciation of the objectives of the present invention and a more complete understanding of its configuration may be had by studying the following description of the preferred embodiment and by referring to the accompanying drawings.

### BRIEF DESCRIPTION OF THE DRAWINGS

FIG. 1 is a perspective view showing a connector according to an embodiment of the present invention.

FIG. 2 is an enlarged, perspective view showing a part of the connector enclosed by dashed line A of FIG. 1.

FIG. 3 is a side view showing the connector of FIG. 1, wherein hidden outlines of a base portion and side arms of a hold-down are illustrated with dashed line.

FIG. 4 is a top view showing the connector of FIG. 1, wherein a part of the connector enclosed by dashed line is enlarged and illustrated.

FIG. 5 is a side view showing the connector of FIG. 1 together with a mating connector, wherein an outline of an upper surface of a board on which the connector is mounted and an outline of a lower surface of a mating board on which the mating connector is mounted are illustrated with dashed line.

FIG. 6 is a perspective view showing the mating connector of FIG. 5.

FIG. 7 is a cross-sectional view showing the connector of FIG. 4, taken along line VII-VII.

FIG. 8 is a cross-sectional view showing the connector of FIG. 4, taken along line VIII-VIII.

FIG. 9 is a cross-sectional view showing the connector of FIG. 4, taken along line IX-IX.

FIG. 10 is a perspective view showing the hold-down of FIG. 1, wherein an outline of a housing is partially illustrated with dashed line.

FIG. 11 is a cross-sectional view showing the connector of FIG. 4, taken along line XI-XI, wherein a middle part of the connector in the pitch direction is not illustrated.

FIG. 12 is another perspective view showing the hold-down of FIG. 10.

FIG. 13 is a top view showing the hold-down of FIG. 10, wherein a hidden outline of a flat-plate portion of the base portion is illustrated with dashed line, and boundaries among the base portion, the side arms and a middle arm are illustrated with chain dotted line.

FIG. 14 is a side view showing the hold-down of FIG. 10, wherein boundaries among the base portion and the side arms are illustrated with dashed line.

FIG. 15 is a perspective view showing a connector and a mating connector of Patent Document 1.

FIG. 16 is a perspective view showing a hold-down of the connector of FIG. 15.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

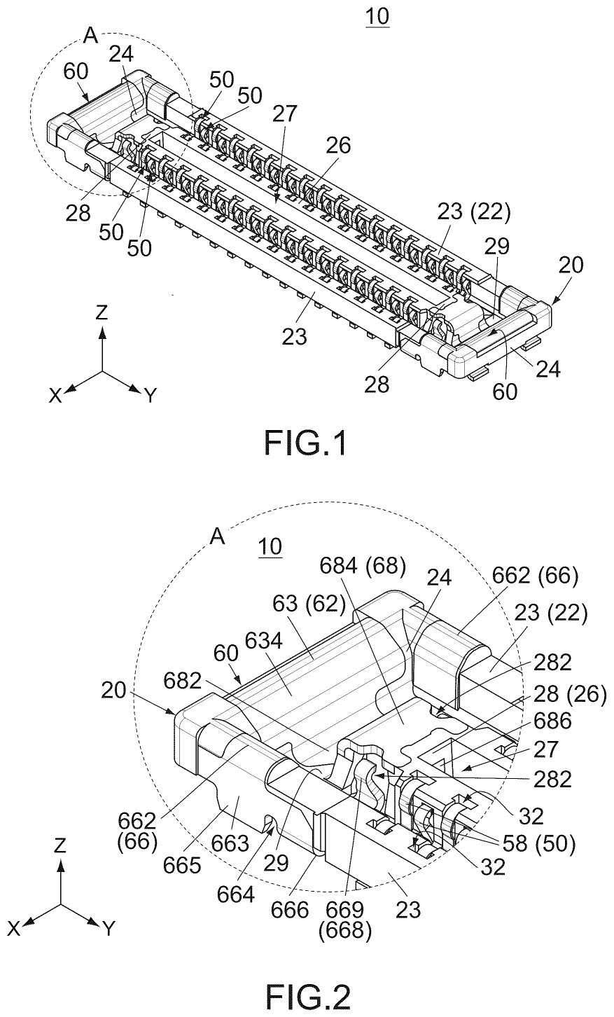

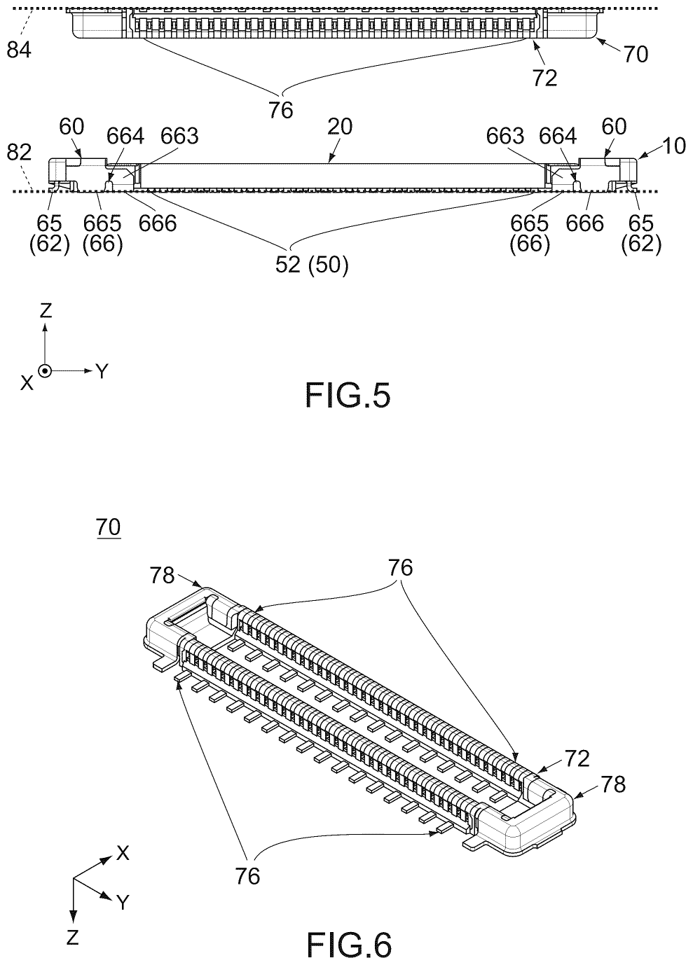

Referring to FIG. 1 together with FIG. 5, a connector 10 according to an embodiment of the present invention is a so-called on-board connector which is configured to be mounted on a board 82. The connector 10 is mateable with a mating connector 70, which is mounted on a mating board 84, along an up-down direction. The up-down direction of the present embodiment is the Z-direction. In the present embodiment, “upward” means the positive Z-direction, and “downward” means the negative Z-direction. The words such as the up-down direction do not indicate the absolute positional relation relative to the ground but merely indicate a relative positional relation in figures.

Referring to FIG. 1, the connector 10 of the present embodiment comprises a housing 20 made of insulator, a plurality of terminals 50 each made of conductor and two hold-downs 60 each made of conductor. The hold-downs 60 are attached to opposite ends of the housing 20 in a pitch direction perpendicular to the up-down direction, respectively, and reinforce the housing 20. The pitch direction of the present embodiment is the Y-direction. In the present embodiment, “inward in the pitch direction” means “toward the middle of the connector 10 in the pitch direction”, and “outward in the pitch direction” means “away from the middle of the connector 10 in the pitch direction”. As described above, the connector 10 has opposite ends to which the hold-downs 60 are attached. The opposite ends of the connector 10 have a mirror symmetric structure with respect to a vertical plane (XZ-plane) perpendicular to the pitch direction.

The connector 10 of the present embodiment has only the aforementioned members and has the aforementioned structure. However, the present invention is not limited thereto. For example, the connector 10 may further comprise another member in addition to the aforementioned members. The opposite ends of the connector 10 may have mirror unsymmetric structure with respect to the XZ-plane. When the opposite ends of the connector 10 are formed as described above, the number of the hold-downs 60 may be one.

Hereafter, explanation will be made about the mating connector 70 (see FIG. 6) of the present embodiment.

Referring to FIG. 6 together with FIG. 5, the mating connector 70 of the present embodiment comprises a mating housing 72 made of insulator, a plurality of mating terminals 76 each made of conductor and two mating hold-downs 78 each made of conductor. The mating hold-downs 78 are attached to opposite ends of the mating housing 72 in the pitch direction, respectively, and reinforce the mating housing 72. The mating terminals 76 are provided so as to correspond to the terminals 50, respectively.

Referring to FIG. 5, under a mated state where the connector 10 and the mating connector 70 are mated with each other, each of the terminals 50 is brought into contact with the corresponding mating terminal 76, and thereby the board 82 and the mating board 84 are electrically connected with each other. The hold-downs 60 are brought into contact with the mating hold-downs 78, respectively, under the mated state. The mating connector 70 of the present embodiment has the aforementioned structure. However, the structure of the mating connector 70 of the present invention is not specifically limited.

Hereafter, explanation will be made about the housing 20 of the present embodiment.

Referring to FIG. 1, the housing 20 of the present embodiment is a unitary member mold of resin and has a peripheral wall 22, an island-like portion 26 and a bottom portion 29. The peripheral wall 22 has two long walls 23 and two short walls 24. Thus, the housing 20 has the two long walls 23 and the two short wall 24.

Each of the long walls 23 of the present embodiment extends along the pitch direction. Each of the short walls 24 of the present embodiment extends along a width direction perpendicular to both the up-down direction and the pitch direction and couples the two long walls 23 together in the width direction. The width direction of the present embodiment is the X-direction. In the present embodiment, “left-side” means the positive X-side, and “right-side” means the negative X-side. In the present embodiment, “inward in the width direction” means “toward the middle of the connector 10 in the width direction”, and “outward in the width direction” means “away from the middle of the connector 10 in the width direction”. Each of the long walls 23 has a size in the pitch direction which is larger than a size of the short walls 24 in the width direction. In other words, the long wall 23 is longer than the short wall 24.

The peripheral wall 22 of the present embodiment is formed of the long walls 23 and the short walls 24 and has a seamless rectangular shape in a horizontal plane (XY-plane) defined by the pitch direction and the width direction. However, the present invention is not limited thereto, but the structure of the peripheral wall 22 can be modified as necessary.

The island-like portion 26 of the present embodiment is enclosed by the long walls 23 and the short walls 24 in the horizontal plane and extends along the pitch direction. The island-like portion 26 is formed with a middle hole 27. The middle hole 27 is located at the middle of the island-like portion 26 in the width direction. The middle hole 27 extends along the pitch direction and passes through the island-like portion 26 in the up-down direction. As a result, the island-like portion 26 is formed with two parts which are located at opposite sides of the middle hole 27 in the width direction, respectively. The island-like portion 26 of the present embodiment has the aforementioned structure. However, the present invention is not limited thereto. For example, the middle hole 27 may be formed as necessary.

The bottom portion 29 of the present embodiment is located at a lower side of the housing 20. The bottom portion 29 couples the island-like portion 26 to each of the long walls 23 and the short walls 24. The island-like portion 26 of the present embodiment has two protected portions 28. The protected portions 28 are located at opposite ends of the island-like portion 26 in the pitch direction, respectively. However, the present invention is not limited thereto. For example, the island-like portion 26 may have only one of the protected portions 28. In this instance, the protected portion 28 may be located at an end of the island-like portion 26 in the pitch direction.

Referring to FIGS. 2, 4 and 9, each of the protected portions 28 of the present embodiment is formed with two movement-allowance portions 282. The two movement-allowance portions 282 are located at opposite sides of the protected portion 28 in the width direction, respectively. Each of the movement-allowance portions 282 is a recess which is recessed inward in the width direction. In other words, the two movement-allowance portions 282 are recessed inward in the width direction.

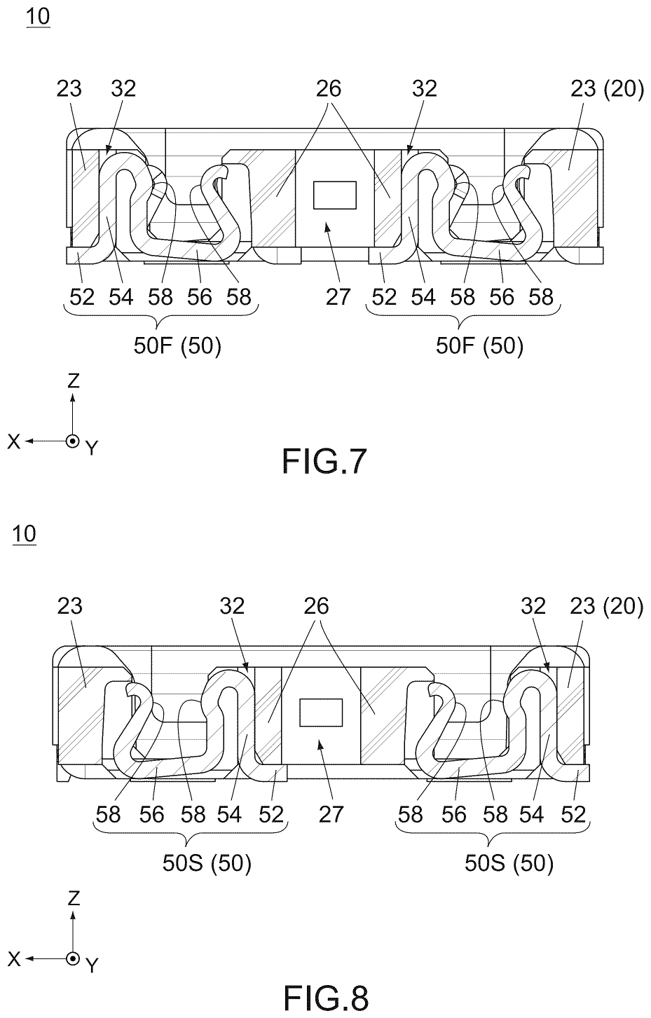

Referring to FIG. 4 together with FIGS. 7 and 8, the housing 20 is formed with a plurality of holding portions 32 which correspond to the terminals 50, respectively. Each of the holding portions 32 is a space which vertically passes through the housing 20. As described later, each of the holding portions 32 holds the corresponding terminal 50.

Hereafter, explanation will be made about the terminals 50 of the present embodiment.

The terminals 50 of the present embodiment consist of a plurality of first terminals 50F and a plurality of second terminals 50S. As can be seen from FIGS. 7 and 8, the second terminal 50S has a shape of the first terminal 50F which is rotated by 180 degrees about an axis extending in parallel to the up-down direction. Thus, the first terminal 50F and the second terminal 50S are components same as each other although their arranged postures are different from each other. However, the present invention is not limited thereto. For example, the first terminal 50F and the second terminal 50S may have structures different from each other.

Each of the terminals 50 of the present embodiment is a so-called bent contact which is formed by bending a single metal plate. Thus, each of the terminals 50 is a single metal plate with bends. Each of the terminals 50 of the present embodiment has a fixed portion 52, a held portion 54, a spring portion 56 and two contact points 58. Each of the terminals 50 has a structure as described below.

Referring to FIG. 5, the fixed portion 52 is configured to be fixed on the board 82 via soldering. As shown in FIGS. 7 and 8, the held portion 54 extends from the fixed portion 52. The held portion 54 is provided with two press-fit projections (not shown). The press-fit projections project from opposite sides of the held portion 54 in the pitch direction, respectively. The spring portion 56 extends from the held portion 54. The spring portion 56 has a U-like shape as a whole and is resiliently deformable easily. The two contact points 58 are located on opposite sides of the spring portion 56 in the width direction, respectively, and face each other in the width direction. Each of the two contact points 58 is supported by the spring portion 56 and is movable in accordance with a resilient deformation of the spring portion 56.

Each of the terminals 50 of the present embodiment has the aforementioned structure. However, the present invention is not limited thereto, but the structure of each of the terminals 50 can be modified as necessary. For example, the number of the contact points 58 may be one.

Referring to FIGS. 7 and 8 together with FIG. 4, the held portion 54 of each of the terminals 50 is press-fit into the corresponding holding portion 32 from below and is thereby securely held. Thus, each of the holding portions 32 holds the held portion 54 of the corresponding terminal 50.

Referring to FIG. 4, the terminals 50 of the present embodiment are divided into two terminal rows 50R. The terminals 50 of each of the terminal rows 50R are arranged along the pitch direction. Each of the terminal rows 50R includes a plurality of the first terminals 50F and a plurality of the second terminals 50S. The first terminals 50F and the second terminals 50S of each of the terminal rows 50R are alternately arranged at regular intervals in the pitch direction.

The two terminal rows 50R are arranged along a left side and a right side of the housing 20 in the width direction, respectively. Each of the first terminals 50F of the left-side terminal row 50R is held by the holding portion 32 formed in the left-side long wall 23. Each of the second terminals 50S of the left-side terminal row 50R is held by the holding portion 32 formed in the left-side part of the island-like portion 26. Each of the first terminals 50F of the right-side terminal row 50R is held by the holding portion 32 formed in the right-side part of the island-like portion 26. Each of the second terminals 50S of the right-side terminal row 50R is held by the holding portion 32 formed in the right-side long wall 23.

Referring to FIGS. 7 and 8, the first terminal 50F and the second terminal 50S which are adjacent to each other in the pitch direction are arranged so that the fixed portions 52 thereof face away from each other in the width direction. As a result of this arrangement, the fixed portions 52 of any two of the terminals 50 adjacent to each other in the pitch direction, which are the first terminal 50F and the second terminal 50S, are located at positions different from each other in the width direction. Thus, the terminals 50 of the present embodiment are arranged in an alternate arrangement (staggered arrangement) so that the terminals 50 can be arranged in a narrow pitch.

The terminals 50 of the present embodiment are arranged as described above. However, the present invention is not limited thereto. For example, each of the terminal rows 50R may include only the first terminals 50F or include only the second terminals 50S. In other words, the terminals 50 do not need to be arranged in a staggered arrangement.

Referring to FIG. 4, according to the present embodiment, it is possible to visually inspect whether the fixed portions 52 are properly soldered on the board 82 (see FIG. 5) or not through the middle hole 27 since the island-like portion 26 is formed with the middle hole 27. However, the present invention is not limited thereto. The middle hole 27 does not need to be formed in an instance in which the terminals 50 are not arranged in a staggered arrangement, for example.

Hereafter, explanation will be made about the hold-downs 60 (see FIG. 1) of the present embodiment.

Referring to FIG. 1, the two hold-downs 60 of the present embodiment are provided so as to correspond to the two short walls 24 of the housing 20, respectively. Each of the hold-downs 60 is insert-molded in the housing 20 and is thereby securely fixed to the housing 20. However, the fixing method of each of the hold-downs 60 to the housing 20 is not specifically limited.

One of the two hold-downs 60 of the present embodiment has a shape of a remaining one of the two hold-downs 60 which is rotated by 180 degrees about an axis extending in parallel to the up-down direction. Thus, the two hold-downs 60 are components same as each other although their arranged postures are different from each other. Each of the hold-downs 60 has a mirror symmetric shape with respect to the YZ-plane. However, the present invention is not limited thereto. For example, the two hold-downs 60 may have structures different from each other.

Hereafter, explanation will be made about one of the hold-downs 60 of the present embodiment. The explanation described below is applicable to each of the hold-downs 60.

Referring to FIGS. 10 and 12 together with FIG. 2, the hold-down 60 of the present embodiment is formed by bending a single metal plate. In other words, the hold-down 60 is a single metal plate with bends. The hold-down 60 has a base portion 62, two side arms 66 and a middle arm 68. The two side arms 66 are connected to opposite sides of the base portion 62 in the width direction, respectively. The middle arm 68 is connected to an inner part of the base portion 62 in the pitch direction. The hold-down 60 of the present embodiment is formed of the aforementioned portions and has the aforementioned structure. Each of the aforementioned portions is a part of the single hold-down 60. However, the present invention is not limited thereto. For example, the hold-down 60 may further have another portion in addition to the aforementioned portions.

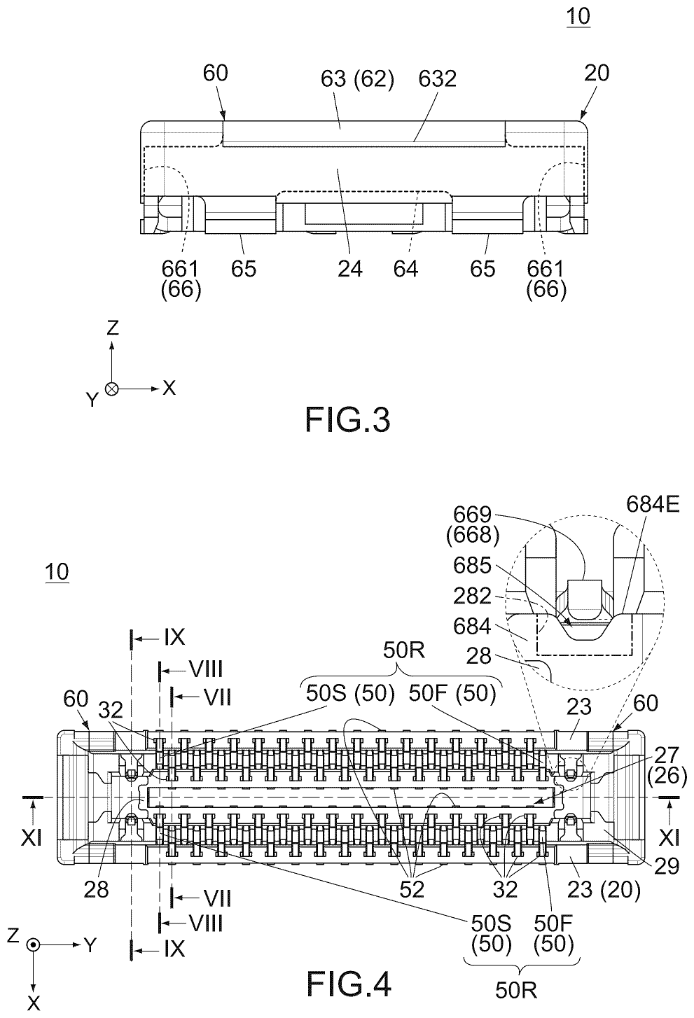

Referring to FIGS. 3 and 12, the base portion 62 of the present embodiment has a cover portion 63, a flat-plate portion 64 and two fixed portions 65.

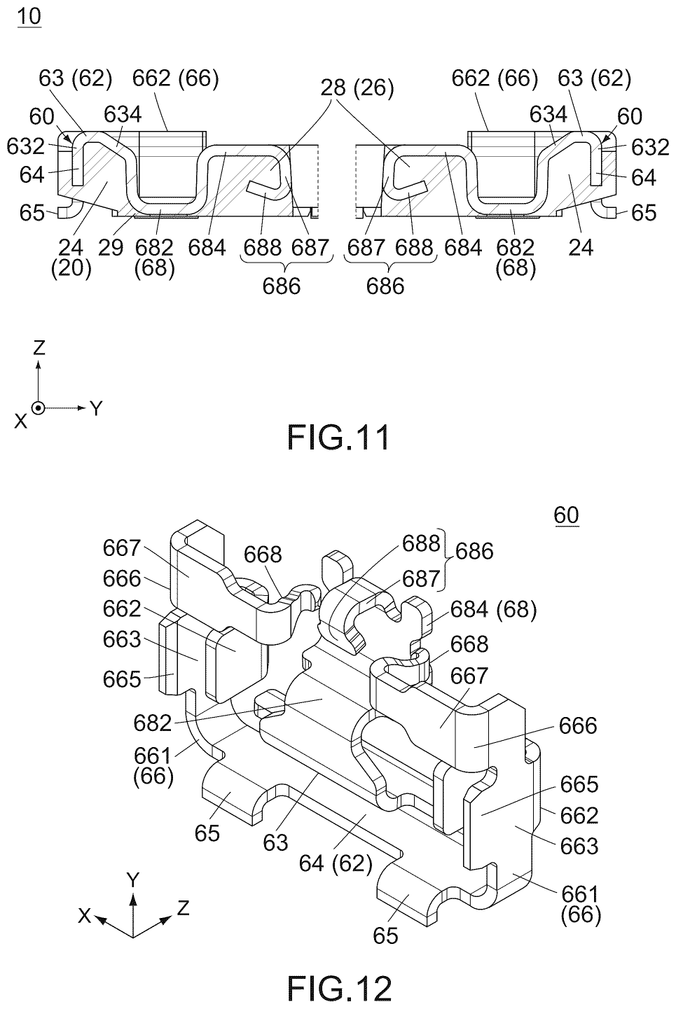

Referring to FIGS. 2 and 11, the cover portion 63 covers the short wall 24 from above. In detail, the cover portion 63 is attached to the short wall 24 so as to straddle the short wall 24 in the pitch direction. The thus-attached cover portion 63 has an outer cover 632 which is located on an outer surface of the short wall 24 in the pitch direction and an inner cover 634 which is located on an inner surface of the short wall 24 in the pitch direction.

Referring to FIGS. 3 and 11, the flat-plate portion 64 is connected to a lower end of the outer cover 632. The flat-plate portion 64 has a flat-plate shape perpendicular to the pitch direction and extends along the width direction. The most part of the flat-plate portion 64 is embedded in the short wall 24.

Referring to FIGS. 3 and 14, the two fixed portions 65 are connected to opposite ends of the flat-plate portion 64 in the width direction, respectively. Each of the fixed portions 65 is exposed outward from the short wall 24 and extends downward from the flat-plate portion 64. Referring to FIG. 12 together with FIG. 5, each of the fixed portions 65 has a lower end which is bent outward in the pitch direction and is configured to be fixed on the board 82 via soldering.

Referring to FIG. 11, the base portion 62 of the present embodiment has the aforementioned structure and reinforces the short wall 24. However, the present invention is not limited thereto. For example, the flat-plate portion 64 and the fixed portions 65 may be provided as necessary.

Referring to FIG. 10, each of the side arms 66 of the present embodiment has a coupling portion 661, a side cover 662, a side portion 663, an additional fixed portion 665, an extending portion 667, a spring portion 668 and a contact point 669. Hereafter, explanation will be made about one of the side arms 66 of the present embodiment. The explanation described below is applicable to each of the side arms 66.

Referring to FIG. 10 together with FIG. 2, the side cover 662 covers the long wall 23 from above. In detail, the side cover 662 is attached to the long wall 23 so as to staddle the long wall 23 in the width direction. The thus-attached side cover 662 has an outer part which is located on an outer surface of the long wall 23 in the width direction and an inner part which is located on an inner surface of the long wall 23 in the width direction. The inner part of the side cover 662 extends downward to a position located in the vicinity of the bottom portion 29 of the housing 20.

The side portion 663 is connected to the outer part of the side cover 662 in the width direction. In detail, the side portion 663 is connected to a lower end of the outer part of the side cover 662 which is located at an outer side of the side cover 662 in the width direction. The side portion 663 has a flat-plate shape perpendicular to the width direction and extends along the pitch direction. The side portion 663 covers an outer surface of the long wall 23 in the width direction. The side portion 663 of the present embodiment is formed with a cut 664 which is located at the middle thereof in the pitch direction. The side portion 663 has two parts which are located at opposite sides of the cut 664 in the pitch direction, respectively.

The additional fixed portion 665 is connected to a lower end of a part of the side portion 663 which is located outward of the cut 664 in the pitch direction. The additional fixed portion 665 extends downward from the side portion 663. Referring to FIG. 12 together with FIG. 5, the additional fixed portion 665 has a lower end which extends straight along the up-down direction and is configured to be fixed on the board 82 via soldering.

Referring to FIG. 2, each of the side cover 662, the side portion 663 and the additional fixed portion 665 of the side arm 66 of the present embodiment has the aforementioned structure and reinforces the long wall 23. However, the present invention is not limited thereto. For example, the additional fixed portion 665 may be provided as necessary.

Referring to FIGS. 10 and 12, the coupling portion 661 of the present embodiment couples the base portion 62 and the side portion 663 together. In detail, referring to FIGS. 3 and 14 together with FIG. 10, the coupling portion 661 extends outward in the width direction from an outer end of the base portion 62 in the width direction along the short wall 24 and then extends along the long wall 23 to an outer end of the side portion 663 in the pitch direction. Referring to FIG. 3 together with FIG. 14, a part of the coupling portion 661 which extends along the short wall 24 is embedded in the short wall 24.

Referring to FIG. 10, the side arm 66 of the present embodiment is coupled to the base portion 62 by the coupling portion 661. However, the present invention is not limited thereto. For example, the side arm 66 may be coupled to the base portion 62 by an alternative portion instead of the coupling portion 661. This alternative portion may couple an upper end of the cover portion 63 and an upper end of the side cover 662 together. However, according to this structure, the cover portion 63 and the side cover 662 are inevitably formed of two predetermined parts of a single metal plate, respectively, the two predetermined parts being adjacent to each other in each of the width direction and the pitch direction. This forming method will restrict design flexibility. For example, in an instance in which the connector 10 has a small size in the width direction, a size of the inner part of the side cover 662, which is located at an inner side of the side cover 662 in the width direction, cannot be made sufficiently long in the up-down direction.

In contrast, each of the cover portion 63 and the side cover 662 of the present embodiment can be formed in various shapes by bending a part of a single metal plate which extends along the width direction. Accordingly, the present embodiment is preferrable from a viewpoint of improvement of design flexibility.

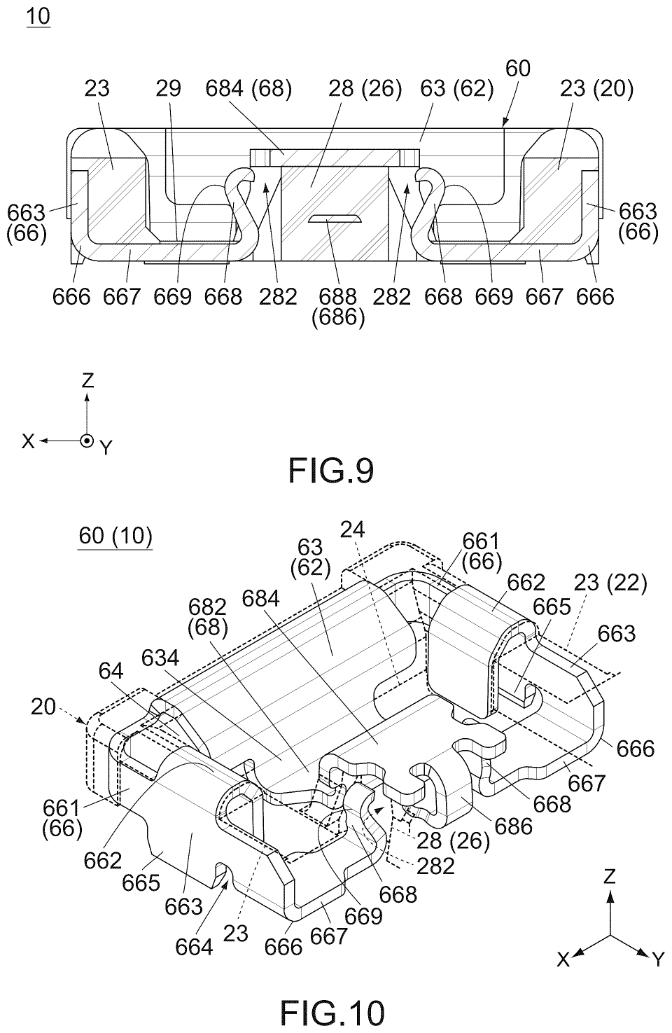

Referring to FIGS. 9 and 10, the extending portion 667 extends inward in the width direction from a lower end of the side portion 663. In detail, the extending portion 667 is connected to a lower end of a part of the side portion 663 which is located inward of the cut 664 in the pitch direction. The extending portion 667 passes under the short wall 24 and then extends to a position located in the vicinity of the protected portion 28 of the island-like portion 26.

The spring portion 668 is connected to an inner end of the extending portion 667 in the width direction. The spring portion 668 extends upward from the extending portion 667 so as to be resiliently deformable. According to the present embodiment, no part of the housing 20 is formed about a lower end the spring portion 668. The thus-arranged lower end of the spring portion 668 is exposed upward and downward from the housing 20. Accordingly, the spring portion 668 can be easily bent. However, the present invention is not limited thereto. For example, the lower end of the spring portion 668 may be embedded in the bottom portion 29 of the housing 20.

The contact point 669 is supported by the spring portion 668 and is movable in the width direction in accordance with a resilient deformation of the spring portion 668. The contact point 669 is easily movable inward in the width direction in accordance with a resilient deformation of the spring portion 668 since the protected portion 28 is formed with the movement-allowance portions 282. Referring to FIG. 2, the contact point 669 is provided on an arc-like part of the spring portion 668 which protrudes outward in the width direction. The thus-provided contact point 669 faces outward in the width direction. The contact point 669 and the contact points 58 of some of the terminals 50 which face outward in the width direction are arranged in a straight line in the pitch direction. Referring to FIG. 9 together with FIG. 6, the contact point 669 of the present embodiment is brought into contact with the mating hold-down 78 of the mating connector 70 and works as a power contact under the mated state. However, the present invention is not limited thereto, but the usage of the spring portion 668 can be modified as necessary.

Referring to FIG. 10, each of the extending portion 667, the spring portion 668 and the contact point 669 of the side arm 66 of the present embodiment has the aforementioned structure. If the spring portion 668 is arranged in the vicinity of the long wall 23, the long wall 23 should be formed with a space which allows a resilient deformation of the spring portion 668. The thus-formed space might degrade strength of the housing 20. In contrast, according to the present embodiment, the long wall 23 does not need to be formed with a space which allows a resilient deformation of the spring portion 668 since the spring portion 668 can be arranged in the vicinity of the island-like portion 26. Accordingly, the housing 20 can be improved in its strength.

According to the present embodiment, the side arm 66 is formed with a bent portion 666 which is located at a boundary between the lower end of the side portion 663 and the extending portion 667. The extending portion 667 of the hold-down 60 can be formed by bending a metal plate, which partially forms the side portion 663, inward in the width direction at a lower end of the side portion 663. Referring to FIG. 9 together with FIG. 5, the boundary between the extending portion 667 and the side portion 663 is the bent portion 666 which is formed as described above. When the thus-formed boundary is soldered on the board 82, a solder fillet is formed on the boundary, and thereby the bent portion 666 can be securely soldered on the board 82.

Referring to FIG. 10, the cut 664 formed in the side portion 663 divides the side portion 663 into two parts which consist of a part formed with the side cover 662 and another part formed with the extending portion 667. However, the present invention is not limited thereto. For example, the side cover 662 may be formed so as to extend over all the side portion 663 without forming the cut 664, and the extending portion 667 may be connected to the whole of the lower end of the side portion 663. However, according to this structure, it is difficult to bent the side cover 662 downward while the extending portion 667 is bent inward in the width direction. Accordingly, the present embodiment is preferable from a viewpoint of easy formation of the side cover 662 and the extending portion 667.

Referring to FIGS. 2 and 11, the middle arm 68 of the present embodiment has a middle portion 682 and a protector 684. The middle portion 682 is connected to a lower end of the inner cover 634 of the base portion 62 and extends inward in the pitch direction from the base portion 62 to the island-like portion 26 along the bottom portion 29 of the housing 20. The protector 684 extends from the middle portion 682 and covers the protected portion 28 of the island-like portion 26.

Referring to FIGS. 9 and 10, the protector 684 is located above the two movement-allowance portions 282 formed in the protected portion 28. As previously described, the two movement-allowance portions 282 allow movements of the spring portions 668 of the two side arms 66 in accordance with resilient deformations thereof, respectively. The spring portions 668 have upper ends which are partially located in the movement-allowance portions 282, respectively, even under an initial sate where the spring portions 668 are not resiliently deformed.

As described above, the protector 684 of the present embodiment is arranged above the spring portions 668 so that the spring portions 668 are protected from above. The thus-arranged protector 684 prevents the spring portions 668 from being brought into abutment with the mating connector 70 during a process in which the mating connector 70 (see FIG. 6) is mated with the connector 10, for example. Thus, the present embodiment provides the connector 10 with a structure which prevents the spring portion 668 from buckling.

The protector 684 of the present embodiment is a metal plate and is hardly abraded even when it is brought into abutment with the mating connector 70 (see FIG. 6). Accordingly, the spring portion 668 can be reliably prevented from buckling while abrasion of the resin of the housing 20 is prevented.

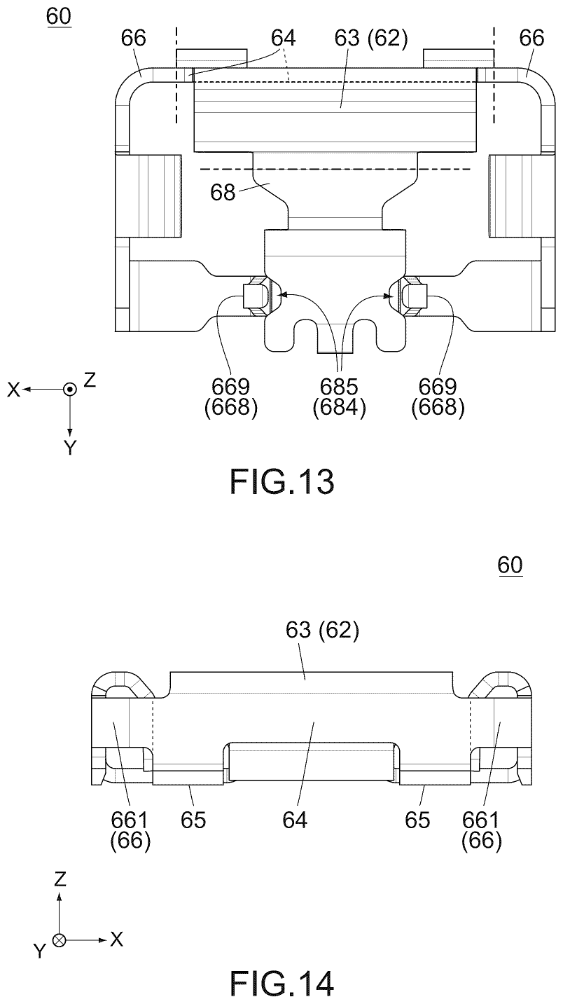

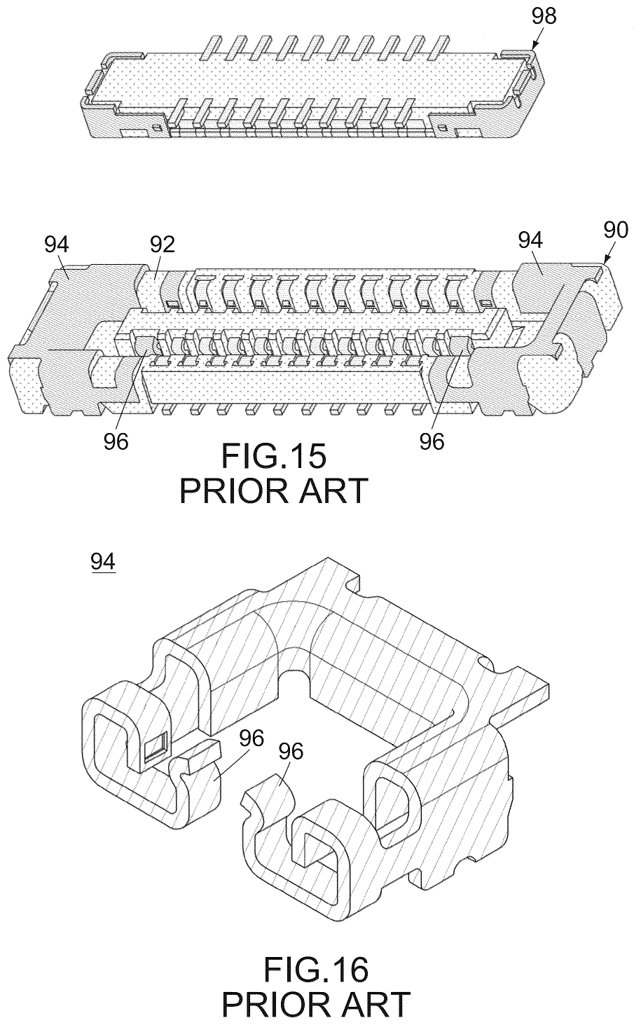

Referring to FIG. 13, the protector 684 of the present embodiment is formed with two recessed portions 685. Referring to FIG. 4, each of the recessed portions 685 is located just over the spring portion 668. In other words, the most part of the metal protector 684 is not located just over the spring portion 668. However, referring to FIG. 4, under a state where the spring portion 668 is not resiliently deformed, an upper end of the spring portion 668 is located inward in the width direction with respect to an outer edge 684E of the protector 684 in the width direction.

According to the aforementioned arrangement, the mating connector 70 (see FIG. 6) is brought into abutment with the protector 684 before being brought into abutment with the spring portions 668. Therefore, the spring portions 668 can be effectively prevented from buckling. Moreover, since the protector 684 is formed with the recessed portions 685, each of the spring portions 668 can be formed by easily bending a metal piece with no interference with the protector 684. However, the present invention is not limited thereto. For example, the recessed portions 685 may be formed as necessary.

Referring to FIG. 11 together with FIG. 12, the middle arm 68 of the present embodiment has an embedded portion 686 in addition to the middle portion 682 and the protector 684. The embedded portion 686 is embedded in the island-like portion 26. In detail, the embedded portion 686 is embedded in the protected portion 28. The embedded portion 686 has a first portion 687 and a second portion 688. The first portion 687 extends downward from the protector 684. The second portion 688 extends outward in the pitch direction from the first portion 687. In detail, the first portion 687 extends downward from an inner edge of the protector 684 in the pitch direction. The second portion 688 extends outward in the pitch direction from a lower end of the first portion 687.

The protector 684 of the present embodiment is embedded in an upper end part of the protected portion 28 and is thereby held by the protected portion 28. Referring to FIG. 2, the protector 684 is located in the vicinity of the middle hole 27 of the island-like portion 26. According to this arrangement, resin might be insufficiently poured around the protector 684 when the protector 684 is insert-molded in the housing 20. As a result, the protector 684 might be insecurely held. In an instance in which the embedded portion 686 is not provided, the protector 684 might be detached from the protected portion 28 when a downward force is applied to the cover portion 63.

In contrast, the embedded portion 686 of the present embodiment works as an anchor so that the protector 684 is securely held by the protected portion 28. However, the present invention is not limited thereto. For example, the embedded portion 686 may be provided as necessary.

While there has been described what is believed to be the preferred embodiment of the invention, those skilled in the art will recognize that other and further modifications may be made thereto without departing from the spirit of the invention, and it is intended to claim all such embodiments that fall within the true scope of the invention.

What is claimed is:

1. A connector comprising a housing and a hold-down, wherein:
the housing has two long walls, two short walls, an island-like portion and a bottom portion;
each of the long walls extends along a pitch direction;
each of the short walls couples the long walls together in a width direction perpendicular to the pitch direction;
the island-like portion is enclosed by the long walls and the short walls in a horizontal plane defined by the pitch direction and the width direction;
the bottom portion is located at a lower side of the housing in an up-down direction perpendicular to both the pitch direction and the width direction;
the bottom portion couples the island-like portion to each of the long walls and the short walls;
the island-like portion has a protected portion;
the protected portion is located at an end of the island-like portion in the pitch direction;
the hold-down has a base portion, two side arms and a middle arm;
the base portion has a cover portion;
the cover portion covers the short wall from above;
the two side arms are connected to opposite sides of the base portion in the width direction, respectively;
each of the side arms has a side cover, a side portion, an extending portion, a spring portion and a contact point;
for each of the side arms, the side cover covers the long wall from above, the side portion is connected to an outer part of the side cover in the width direction and extends along the pitch direction, the extending portion extends inward in the width direction from a lower end of the side portion, the spring portion extends upward from the extending portion so as to be resiliently deformable, and the contact point is supported by the spring portion;
the middle arm has a middle portion and a protector;
the middle portion extends inward in the pitch direction from the base portion;
the protector extends from the middle portion and covers the protected portion of the island-like portion;
the protected portion is formed with two movement-allowance portions;
the two movement-allowance portions are recessed inward in the width direction and allow movements of the spring portions in accordance with resilient deformations thereof, respectively;
the protector is located above the two movement-allowance portions; and
each of the side arms is formed with a bent portion which is located at a boundary between a lower end of the side portion and the extending portion.

2. The connector as recited in claim 1, wherein:
each of the side arms has a coupling portion; and
the coupling portion of each of the side arms couples the base portion and the side portion together.

3. The connector as recited in claim 1, wherein:
the middle arm has an embedded portion;
the embedded portion is embedded in the island-like portion;
the embedded portion has a first portion and a second portion;
the first portion extends downward from the protector; and
the second portion extends outward in the pitch direction from the first portion.

4. The connector as recited in claim 2, wherein:
the middle arm has an embedded portion;
the embedded portion is embedded in the island-like portion;
the embedded portion has a first portion and a second portion;
the first portion extends downward from the protector; and
the second portion extends outward in the pitch direction from the first portion.
